(19) United States
(12) Patent Application Publication
(10) Pub. No.: US 2009/0033957 A1
(43) Pub. Date: Feb. 5, 2009

(54) CALIBRATION CHART CONFIGURATION SYSTEM

(75) Inventor: Stephen James Hardy, West Pymble (AU)

Correspondence Address: FITZPATRICK CELLA HARPER & SCINTO, 30 ROCKEFELLER PLAZA, NEW YORK, NY, 10112, US

(73) Assignee: CANON KABUSHIKI KAISHA, Tokyo (JP)

(21) Appl. No.: 12/147,136

(22) Filed: Jun. 26, 2008

(30) Foreign Application Priority Data
Jul. 31, 2007 (AU) 2007203556

(51) Int. Cl. H04N 1/60

(52) U.S. Cl. 358/1.9

(57) ABSTRACT

A method (300) is disclosed of calibrating a printing device (110). The method (300) starts by printing (310) a calibration chart (800) comprising a plurality of machine readable marks (920 and 925) and at least one calibration area (820). The machine readable marks (920 and 925) are disposed on different sides of the calibration area (820). Each machine readable mark (920 and 925) independently identifies a type of the calibration area (820). The printed calibration chart is next imaged (330). Finally, the calibration area (820) is utilized to calibrate the printing device (110) in accordance with the identity of the type of calibration area (820).

### CROSS-REFERENCE TO RELATED PATENT APPLICATIONS

This application claims the right of priority under 35 U.S.C. §119 based on Australian Patent Application No.2007203556, filed 31 Jul. 2007, which is incorporated by reference herein in its entirety as if fully set forth herein.

### FIELD OF THE INVENTION

The current invention relates generally to printing systems and, in particular, to the management of calibration charts to adjust printing parameters in print systems.

### BACKGROUND

Some printers operate by moving a print head across a page. Inkjet printers are in this class and have in recent years achieved high resolution and accurate colour reproduction which has resulted in the rapid spread of their use. To perform fast high resolution printing a printer of this type generally employs a print head that contains multiple sets of nozzles for ejecting ink droplets, with the nozzles being densely arranged on the print head. Such print heads are often configured to eject ink while moving both forwards and backwards in the main scan direction. Between each pass a paper feed mechanism will often move the paper under the print-head forward in the transverse or sub-scan direction. In this manner the print head passes over the same area of the paper, laying down a different pattern of ink in each pass. Furthermore, when the paper feed mechanism moves the paper under the print head, often the paper is moved a distance smaller than the height of the print head. This means that different parts of the print head are used to print on the same area of the paper.

To ensure a high accuracy reproduction, free from noise and other artefacts, it is necessary to have a high degree of certainty in the relative spatial positioning of drops between both forward and reverse passes of the print head in the scan direction, in the relative position of drops made before and after a line feed, and in the relative spatial positioning of drops made from different parts of the print head. Ensuring such a high degree of certainty is made significantly more difficult due to the requirement that users of the printers must be able to replace ink tanks and even whole print heads. Furthermore, as the mechanical components of the printer wear as the printer is used, the relative positioning of the printed dots on different passes of the print head will change.

The requirement for high accuracy in dot placement over a long time and multiple print heads has led to the development of various user driven printer calibration methods. These calibration methods rely on the printer being configured internally with adjustable parameters that may be effectively used to adjust the nozzle firing times and line feed distances to maximise the accuracy of the reproduction produced by the printer. Many such methods are known in the art and in the past they have generally consisted of the user causing the printer to print a test pattern which contains regions that have been printed with different values of some adjustable parameter within the printer. The test patterns are designed so that a user will see particular sorts of visual artefacts in all but the optimal adjustment parameter. When the user has determined the optimal adjustment parameter this is fed back to the printer in some manner and that adjustment parameter is used until the next calibration.

Given the large number of adjustable parameters in a print system and the high quality required for modern printers, maintaining a well calibrated printer may require significant effort from the user. Generally this problem for the user is ameliorated by reducing the number of calibration steps required by the user to less than a complete set and thereby compromising on the completeness and accuracy of the calibration.

User driven calibration procedures also suffer from a further drawback that is becoming more problematic as inkjet printing technology goes to higher resolutions. Current generations of inkjet printers print with an internal resolution of 2400 or 4800 dpi. These dots need to be placed with an accuracy of around 10 or 5 microns, respectively. User driven calibration at these and higher resolutions is increasingly unreliable.

Attempts to overcome this problem have been made in the form of automatic calibration systems that rely on optical scanners to image the test patterns and then, with digital image processing, to measure the artefacts caused by errors in the printing process. These measurements are then fed back into the printing device to correct those defects measured.

There are a number of drawbacks to this solution. This process requires a scanner, which must either be embedded in the printer as a multi-function printer (MFP) or a separate scanner which the user must own. It also takes considerable computing resources to perform this calibration, which in a standalone device such as MFP, can increase the cost of the unit considerably. In particular, storage of an entire uncompressed A4 scan at a high enough resolution to allow accurate measurement requires a large amount of storage. For instance, a 600 dpi scan of an A4 test target would require 90 MB of random access memory.

Another problem is that of user error in dealing with the calibration charts. Due to the large number of parameters that may be calibrated in an automatic system, it is possible that a single printer may print out multiple types of calibration charts. For instance, a printer may print a linefeed calibration chart, a colour calibration chart, or a head alignment chart. Also, the user may have printed out over time a number of the same type of calibration chart. Given this, some of the errors the user may make are:

the user may place the incorrect type of calibration chart on the scanner during a scanning operation,

the user may place the correct type of calibration chart on the scanner, but it may not be the latest such calibration chart to be printed, and

the user may place the correct test chart on the scanner but in the incorrect orientation.

These difficulties make the calibration of printers that use an optical scanner expensive and error prone.

### SUMMARY

It is an object of the present invention to substantially overcome, or at least ameliorate, one or more disadvantages of existing arrangements.

According to an aspect of the present disclosure, there is provided a method of calibrating a printing device, the method comprising the steps of:

printing a calibration chart comprising a plurality of machine readable marks and at least one calibration area, said machine readable marks being disposed on different sides of the calibration area, each machine readable mark independently identifies a type of the calibration area;

imaging the printed calibration chart; and

utilizing said calibration area to calibrate said printing device in accordance with the identity of the type of calibration area.

According to another aspect of the present disclosure, there is provided a multifunction printer for calibrating a printing device, said multifunction printer comprising:

printing unit for printing a calibration chart comprising a plurality of machine readable marks and at least one calibration area, said machine readable marks being disposed on different sides of the calibration area, each machine readable mark independently identifies a type of the calibration area;

scanning unit for imaging the printed calibration chart; and

processing means for utilizing said calibration area to calibrate said printing device in accordance with the identity of the type of calibration area.

According to still another aspect of the present disclosure, there is provided an apparatus for calibrating a printing device, said apparatus comprising:

printing unit for printing a calibration chart comprising a plurality of machine readable marks and at least one calibration area, said machine readable marks being disposed on different sides of the calibration area, each machine readable mark independently identifies a type of the calibration area;

scanning unit for imaging the printed calibration chart; and

processing means for utilizing said calibration area to calibrate said printing device in accordance with the identity of the type of calibration area.

According to still another aspect of the present disclosure, there is provided a computer readable medium, having a program recorded thereon, where the program is configured to make a computer execute a procedure of calibrating a printing device, the program comprising:

code for printing a calibration chart comprising a plurality of machine readable marks and at least one calibration area, said machine readable marks being disposed on different sides of the calibration area, each machine readable mark independently identifies a type of the calibration area;

code for imaging the printed calibration chart; and

code for utilizing said calibration area to calibrate said printing device in accordance with the identity of the type of calibration area.

Other aspects of the invention are also disclosed.

### BRIEF DESCRIPTION OF THE DRAWINGS

One or more embodiments of the present invention will now be described with reference to the drawings, in which:

FIG. 1 shows a multifunction printer;

FIG. 2 shows a schematic block diagram of the internal structure of the multifunction printer;

FIG. 3 shows a schematic flow diagram of a calibration process;

FIG. 4 shows a schematic flow diagram illustrating the construction and printing of a calibration chart;

FIG. 5 shows a schematic flow diagram illustrating the construction of a first configuration area;

FIG. 6 shows a schematic flow diagram illustrating the construction of a second configuration area;

FIG. 7 shows a schematic flow diagram illustrating analysis of a scan of the calibration chart;

FIG. 8 is an illustration of a possible spatial layout of the areas of the configuration chart;

FIG. 9 is an illustration of a possible spatial layout of the first configuration area;

FIG. 10 is an illustration of a possible embodiment of the first configuration area;

FIG. 11 is an illustration of a possible spatial layout of the second configuration area; and

FIG. 12 is an illustration of a possible embodiment of the second configuration area.

### DETAILED DESCRIPTION

Where reference is made in any one or more of the accompanying drawings to steps and/or features, which have the same reference numerals, those steps and/or features have for the purposes of this description the same function(s) or operation(s), unless the contrary intention appears.

Apparatus

A multifunction printer (MFP) may be described as a printer-scanner combination device. The MFP may be connected to a personal computer to receive data for printing, and also for passing data obtained trough scanning to the personal computer. Such devices can also operate as photocopiers by scanning a document and then print the image data obtained through the scan. Also, such devices can operate as facsimile machines by scanning a document and sending the image data, or receiving image data and printing the same.

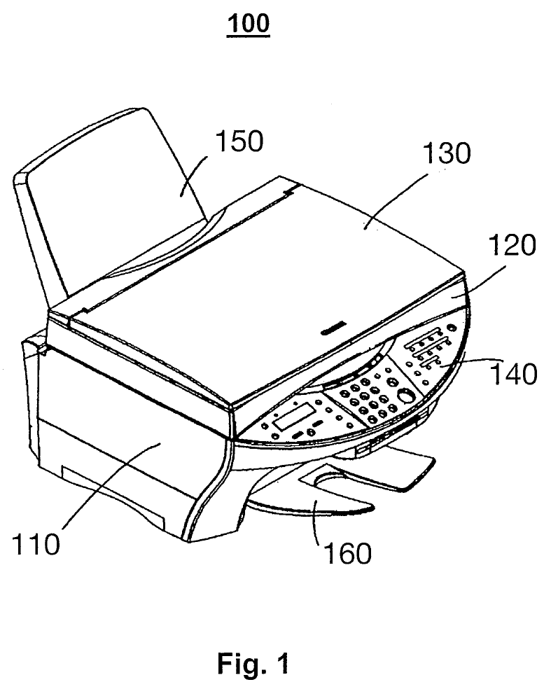

FIG. 1 shows such an MFP 100 used in the preferred implementation of the present invention. The MFP 100 includes a printing unit 110, a scanning unit 120, a scanner cover 130 covering the platen of the scanning unit 120, a control unit 140 which provides user interfaces through which a user controls the MFP 100, a paper holder 150 for receiving blank paper, and an output tray 160 into which the paper is deposited after the printing unit 110 has printed on the paper.

When the MFP 100 functions as a printer, paper is drawn from the paper holder 150 into the printing unit 110 where a movable inkjet head is used to deposit ink onto the paper in the desired pattern, and the resulting paper containing printed matter is deposited onto the output tray 160.

When the MFP 100 functions as a scanner, a document or book is placed on the scanner platen, under the scanner cover 130, a button is pressed on control panel of the control unit 140, and a movable scan head inside the scanner unit 120 is passed across the document, imaging it. The scanner data may be sent to an external computing device, may be used to print a copy of the document using the printing unit 110, or the data may be processed internally by the MFP 100.

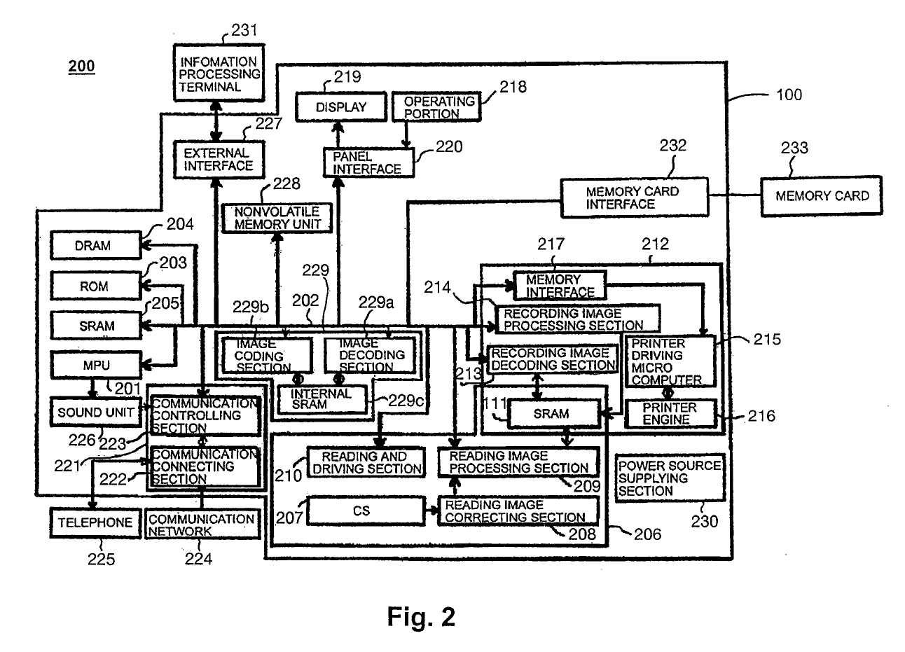

FIG. 2 shows a schematic block diagram of the internal components of the MFP 100. The MFP 100 includes a microprocessor unit (MPU) 201 for controlling the entire MFP 100 via a system bus 202. A Read-only Memory (ROM) 203 is provided for storing program code, initial value data, table data or the like, and is used in the operation of the MPU 201. Dynamic Random Access Memory (DRAM) 204 is used as image buffer, image memory or the like, and is used as a buffer for temporarily storing data at the time of transmitting or receiving data with respect to an image processing terminal 231, such as a computer.

Moreover, the DRAM 204 is used also as a memory for accumulating image data received via a communicating section 221, image data read out by a reading section 206, and image data transmitted from the information processing terminal 231 as a file. Static Random Access Memory (SRAM) 205 is used for a user registration data area, a work area, or the like. The DRAM 204 and SRAM 205 are each protected by a battery back up (not illustrated).

The reading section 206 has a contact sensor 207, a reading image correcting section 208, a reading image processing section 209, a reading and driving section 210, and an SRAM 211, or the like. The reading and driving section 210 drives the contact sensor 207 by driving the reading and driving section 210. The contact sensor 207 converts a document to an electric image signal. Shading correction, or the like, is executed on the image signal by the reading image correcting section 208. An image process is executed by the reading image processing section 209 which outputs processed image data. The SRAM 211 is used as a buffer at the time of executing the image process.

An ink jet recording section 212 includes a recording image decoding section 213, a recording image processing section 214, a printer controlling microcomputer 215, a printer engine 216, and a recording interface 217. The ink jet recording section 212 shares the SRAM 211 with the reading section 206. The recording image decoding section 213 converts image data to raw image data. The recording image processing section 214 applies to the raw image data image processing, such as resolution conversion, image variable power, smoothing, density correction, or the like for converting the raw image data to processed image data. The SRAM 211 is used as a buffer at the time of the data conversion. The printer controlling microcomputer 215 has a recording controlling MPU for controlling the operations of the ink jet recording section 212, a ROM for describing various instructions for executing the recording control, means for reading out the instructions from the ROM, processing means for processing the read out instructions, a RAM capable of inputting the information needed by the processing means, and outputting means for outputting a signal produced by the processing means. The input and output of the signal is executed for the recording control of the printer engine 216. The recording interface 217 is an interface for cooperation between the printer controlling microcomputer 215 and the MPU 201.

The MFP 100 further includes an operating portion 218, which has various key switches, such as ten numeral keys or the like, for commanding the operations of the MFP 100 and inputting various kinds of information. A display is provided, which has a Liquid Crystal Display (LCD), Light Emitting Diodes (LEDs), or the like, for indicating the state of the MFP 100. A panel interface 220 provides cooperation between the MPU 201, the operating portion 218 and the display 219.

The communicating section 221 includes a communication connecting section 222, such as a line connecting unit, and a communication controlling section 223, such as a modem, for executing the line control. The communication section 221 provides an interface between the MFP 100 and a communication network 224 and a telephone 225.

A sound unit 226, having a speaker or the like, provides audible notification of various states of the MFP 100 to the user.

An external interface 227 is provided for transmitting and receiving data between the MPU 201 and the information processing terminal 231 which controls the MFP 100.

A non-volatile memory unit 228 is provided for storing image data without risk of erasing the data even in the case the power source is switched off. The non-volatile memory unit 228 has a flash memory, a hard disc, a RAM with a battery back up, or the like.

An image coding/decoding section 229 is used for coding and decoding image data. The image coding/decoding section 229 has an image decoding section 229a, an image coding section 229b, and an internal SRAM 229c. The image decoding section 229a accepts coded image data, for instance, coded according the JPEG image compression standard, and decodes it to an uncompressed form. The image coding section 299b accepts uncompressed image data and produces encoded image data, for instance, image data coded according to the JPEG image compression standard. Both the image decoding section 229a and the image coding section 229b utilise the internal SRAM 229c for storage of encoded and partially encoded and unencoded image data.

The MFP 100 further includes a power source supplying section 230 for supplying electrical power to the MFP 100. Finally, the MFP 100 includes a memory card interface 232 for communicating with a detachable memory card 233 which stores data on flash memory, or the like.

Process

During a print operation, the MPU 201 performs many image processing operations to improve the visual quality of the printed output. Some of the image processing operations are designed to compensate characteristics of the printing unit 110. For instance, colour conversion may be performed to adapt the colours of the output to account for the colours of the constituent inks that are being used to produce the printed output. Tables and other data used to make these conversions are stored in the SRAM 205. Other image processing operations are designed to compensate for limitations or inaccuracies in the printing process. For instance, when using an inkjet printing head that prints both in the forward and reverse directions, it is necessary to adjust the nozzle firing times for each printer to ensure that ink drops fired during the forward pass are in the correct position in the final print relative to ink drops fired during the reverse pass of the printing head. Such nozzle firing time adjustments are stored in the SRAM 205.

As the MFP 100 is used, many of the characteristics of the printer unit 110 change, due to mechanical wear on the printer unit 110, inkjet nozzle clogging, and the like. This means that the parameters for the printer unit 110 stored in the SRAM 205 during manufacture are no longer appropriate for the printer unit 110 and the printer unit 110 requires recalibration. This recalibration may be initiated by a user through the control unit 140, through controlling software on an attached information processing terminal 231, or by the printer unit 110 itself after a fixed number of prints or after a fixed amount of time.

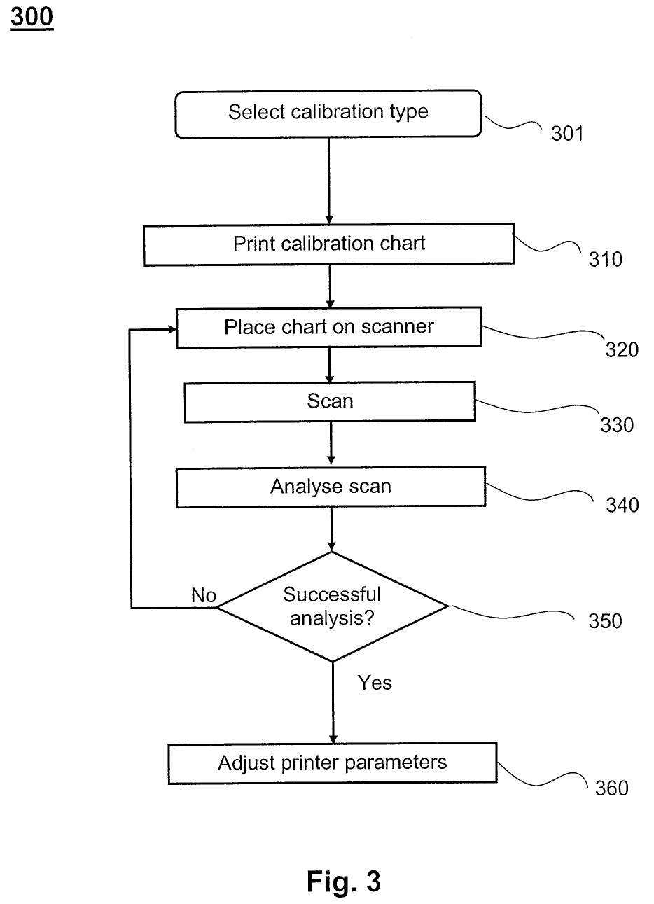

The processes of FIGS. 3 to 7 may be implemented as software, such as one or more application programs executable within the MFP 100. In particular, one or more of the steps of the described processes are effected by instructions in the software that are carried out within the MFP 100. The instructions may be formed as one or more code modules, each for performing one or more particular tasks. The software may be stored in a computer readable medium, including the storage devices described below, for example. The software may be loaded into the MFP 100 from the computer readable medium, and then executed by the MFP 100. A computer readable medium having such software or computer program recorded on it is a computer program product. The use of the computer program product in the MFP 100 preferably effects an advantageous apparatus for implementing the described processes.

Still further, the software can also be loaded into the MFP 100 from other computer readable media. Computer readable media refers to any storage medium that participates in providing instructions and/or data to the MFP 100 for execution and/or processing. Examples of such media include floppy disks, magnetic tape, CD-ROM, a hard disk drive, a ROM or integrated circuit, a magneto-optical disk, or a computer readable card such as a PCMCIA card and the like, whether or not such devices are internal or external of the MFP 100. Examples of computer readable transmission media that may also participate in the provision of instructions and/or data include radio or infrared transmission channels as well as a network connection to another computer or networked device, and the Internet or Intranets including e-mail transmissions and information recorded on Websites and the like.

FIG. 3 shows a schematic flow diagram of a calibration process 300. As described below, the process 300 comprises steps of printing a calibration chart comprising at least one calibration area and utilizing the calibration area to calibrate the printing unit 110 in accordance with the identity of the type of calibration area. The calibration process 300 starts in step 301 where the type of calibration to be performed is chosen by a user. The type of calibration to be carried out may be a line feed calibration, colour calibration, head tilt calibration, bi-directional head registration, nozzle clogging checks etc.

Next, in step 310, a calibration chart is generated by the MPU 201 and printed using the printing unit 110. In step 320, the printed calibration chart is placed on the scanning unit 120 by the user and the scanner cover 130 is closed. A button on the control panel of the control unit 140 is pressed by the user to initiate a scan of the printed calibration chart by the scanning unit 120, which occurs in step 330. In step 340 the scan data is analysed by the MPU 201 to determine calibration parameters.

In step 350 it is determined whether step 340 successfully determined the calibration parameters. If the analysis of step 340 was unsuccessful, then a message is presented to the user on the display 219, asking the user to reposition the printed calibration chart on the scanning unit 120, or to repeat the printing of the calibration chart. The repositioned calibration chart is again scanned and analysed in steps 330 and 340 until step 350 determines that step 340 successfully determined the calibration parameters.

If it is determined in step 350 that the scan analysis of step 340 was successful then in step 360 the printer parameters are adjusted by the MPU 201 by writing the newly determined calibration parameters to the SRAM 205, over the old calibration parameters. In this manner the calibration of the printing unit 110 is kept up to date and the printing unit 110 prints optimally.

Calibration Chart Construction and Printing

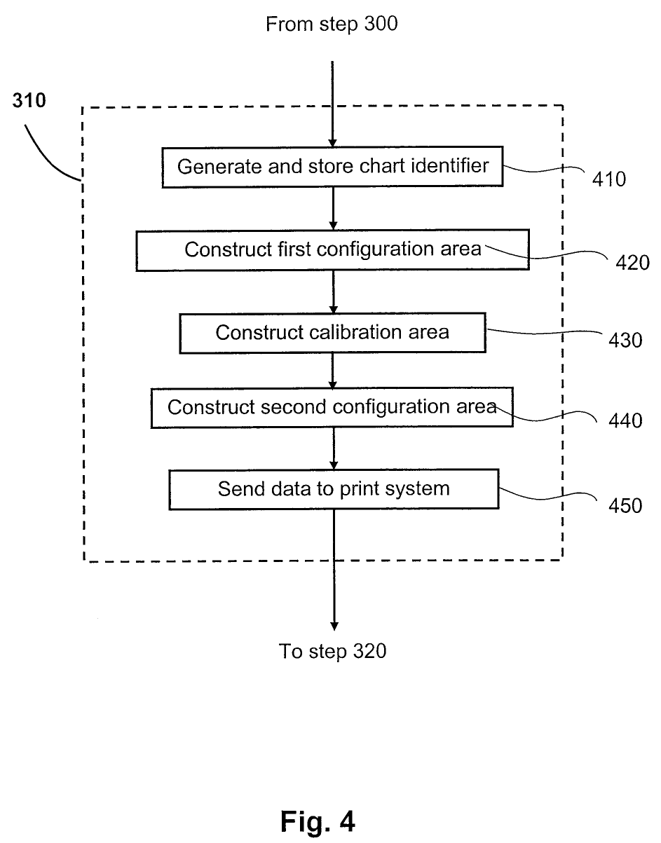

Step 310, in which the calibration chart is generated by the MPU 201 and printed using the printing unit 110 is now described in more detail with reference to FIG. 4 where a schematic flow diagram of step 310 is shown. The type of calibration chart to be generated is an input to step 310. The printing unit 110 is configured to accept bitmap data from the MPU 201.

Step 310 starts in sub-step 410 where a chart identifier is generated and stored in SRAM 205 for later retrieval. In the preferred implementation the chart identifier consists of two numbers, with the first number being a five digit decimal code which identifies the type of calibration chart. For instance, a line feed calibration chart may be given a first number of “00001”. Other calibration charts have other distinct first numbers which are used to distinguish them. The second number of the chart identifier is an identifier uniquely identifying the particular calibration chart that is printed. The second number is also a 5 digit code, and for illustrative purposes this is given the value of “10245”.

In sub-step 420 a first configuration area is constructed. Sub-step 430 follows where a calibration area is constructed. The calibration area typically contains some printed data in some configuration that, after analysis, allows the calculation of some optimised value of a configuration parameter of the MFP 100. A second configuration area is then constructed in sub-step 440. Step 310 ends in sub-step 450 where bitmap data describing the first and second configuration areas and calibration area is sent to the printing unit 110 for printing. While in the preferred implementation all of the calibration chart data is prepared before the bitmap data is sent to the printing unit 110, in other possible implementations the various areas may be sent to the printing unit 110 as they are generated.

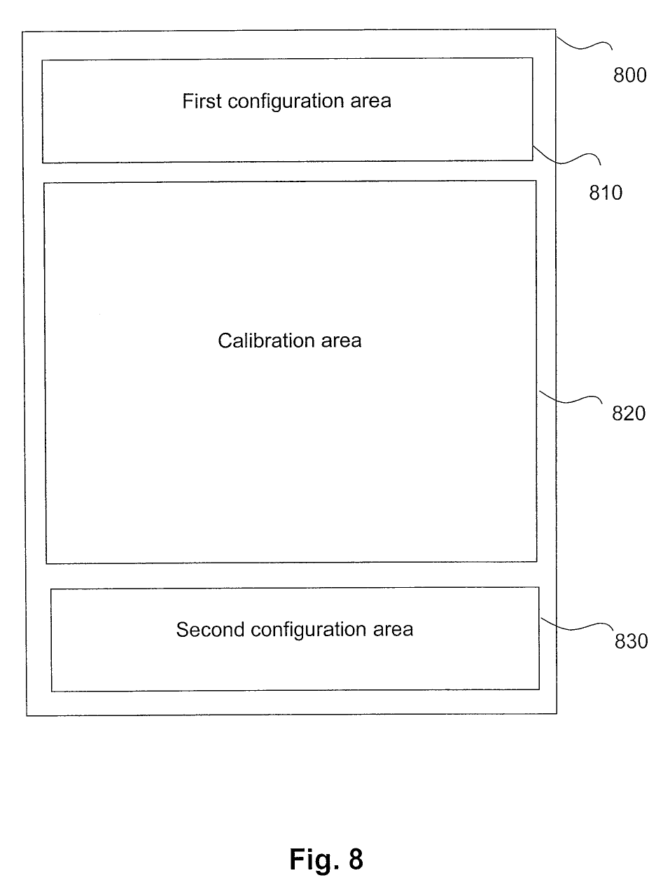

An illustration of the layout of the areas of the calibration chart 800 is shown in FIG. 8. In the preferred implementation, the first configuration area 810 is placed at the top of the calibration chart 800, above the calibration area 820 and the second configuration area 830 is placed below the calibration area 820. While the layout illustrated shows the first configuration area 810, the calibration area 820, and the second configuration area 830, as rectangular regions that are disjoint spatially, the areas 810, 820 and 830 do not have to be rectangular. The calibration area 820 may also extend into one or both configuration areas 810 and 830.

First Configuration Area

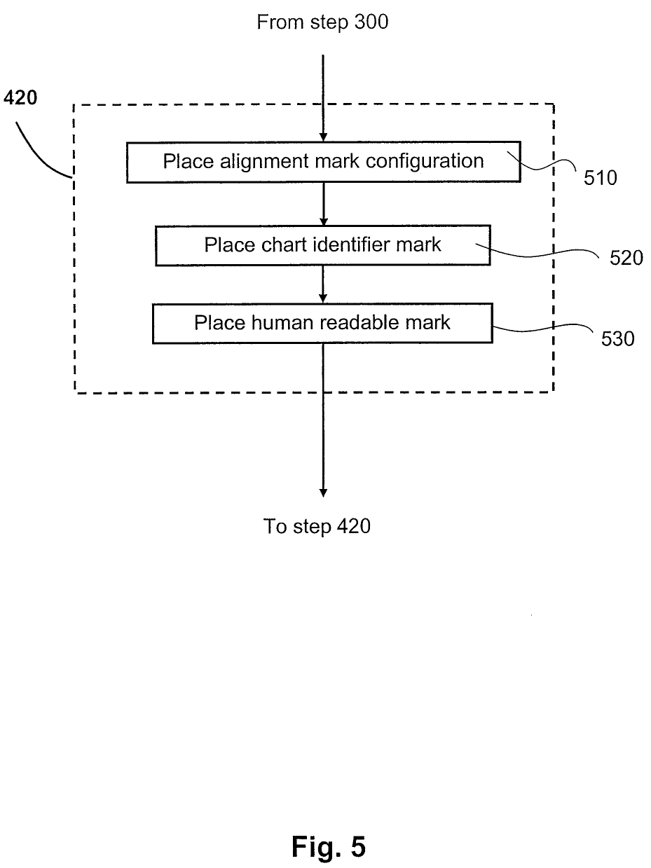

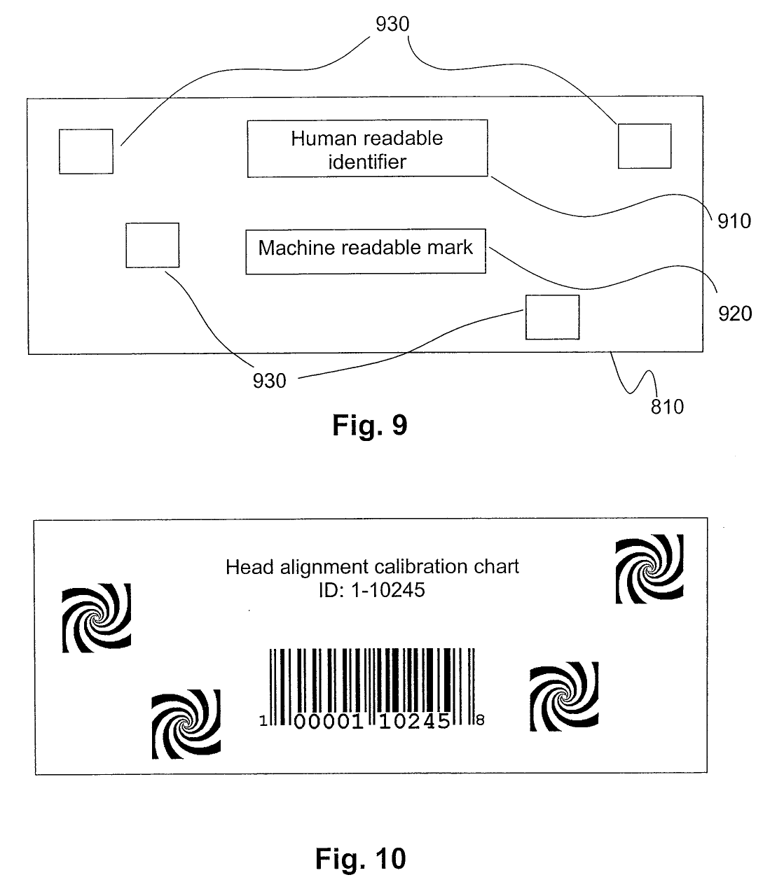

The construction of the first configuration area 810, performed in sub-step 420, is now described in more detail with reference to FIG. 5 where a schematic flow diagram of step 420 is shown. Step 420 starts in sub-step 510 where a set of alignment marks are placed into the first configuration area 810. In the preferred implementation the first configuration area is 9600 pixels wide and 2000 pixels high, and is to be printed at 1200 dpi. Four alignment marks are added to the first configuration area 810. An illustrative configuration of the alignment marks 930 is shown in FIG. 9. Representative centres of the alignment marks 930 are given by:

M1: (x,y)=(1000, 800) (1)

M2: (x,y)=(9000, 400) (2)

M3: (x,y)=(2000, 1200) (3)

M4: (x,y)=(8000, 1600) (4)

The alignment marks 930 are preferably square with a height of 400 pixels. Other spatial positions are acceptable, as long as no three of the alignment marks 930 are co-linear and the alignment marks 930 do not overlap any of the other alignment marks 930 in the first configuration area 810.

The alignment marks 930 are scale invariant spiral marks defined by:

s(x, y)=(255/2)*round(1+cos(α log r+kθ)) (5)

where α and k are pattern parameters, and

$$r = \sqrt{{x}^{2} + {y}^{2}} \\ θ = arctan ( \frac{y}{x} ) \qquad ( 6 )$$

Preferred values of parameters α and k are α=0.04 and k=6. These scale invariant spiral marks are advantageous as alignment marks in that they can be detected regardless of their rotation and scale. Of course, other alignment marks and alignment systems may be used in the first configuration area 810, however it is necessary that the alignment marks 930 allow the determination of the position of the chart on the scanning unit 120 only with reference to the scan of the first configuration area 810 and knowledge of the alignment mark positions on the printed page. Typically, the machine readable marks are disposed on different sides of the calibration area, each machine readable mark independently identifying the type of the calibration area.

Referring also to FIG. 5, in sub-step 520 the chart identifier generated in step 410 is placed in the first configuration area 810 as a machine readable mark. In the preferred implementation, the machine readable mark is a barcode and the barcode symbols are encoded using the UPC-A code format. These symbols are well known in the art and methods for generating and writing them into images and reading them from images are readily available. FIG. 9 also shows a representative position for the machine readable mark 920, where the top left coordinate of the machine readable mark 920 is at (x,y)=(4000, 1000) and the lower right coordinate is at (x,y)=(6000,1500).

Sub-step 530 follows where a human readable identifier is placed in the first configuration area 810. In the preferred implementation the human readable identifier is a text label that contains the name of the type of calibration chart and the chart identifier. A representative position for the human readable identifier 910 is shown in FIG. 9, where the top left coordinate of the human readable identifier 910 is at (x,y)=(3500, 200).

FIG. 10 shows an illustrative example of the first configuration area 810 showing the alignment marks 930, the unique identifier coded in the machine readable mark 920 and the human readable identifier 910. Step 420 concludes after sub-step 530 is performed.

Second Configuration Area

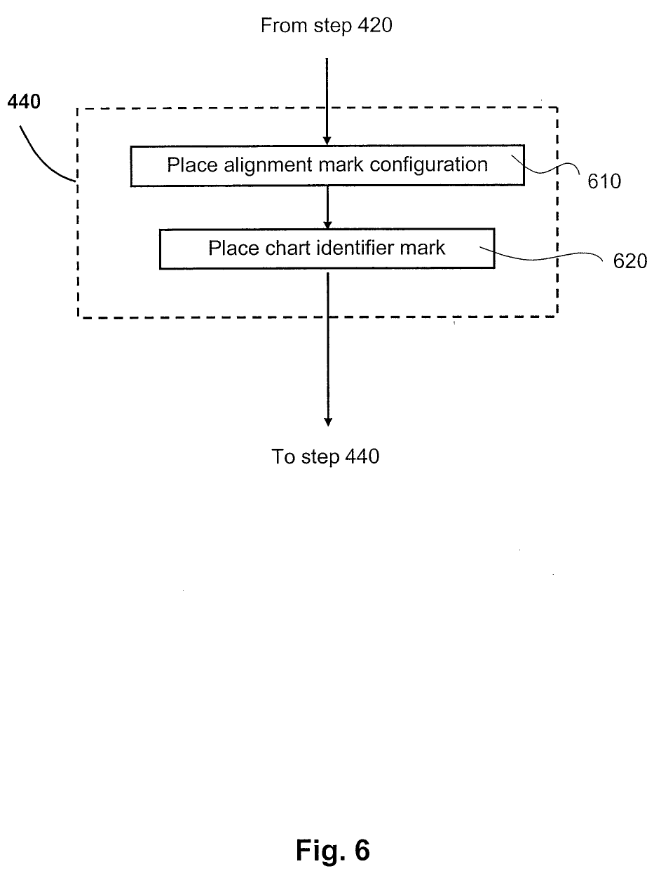

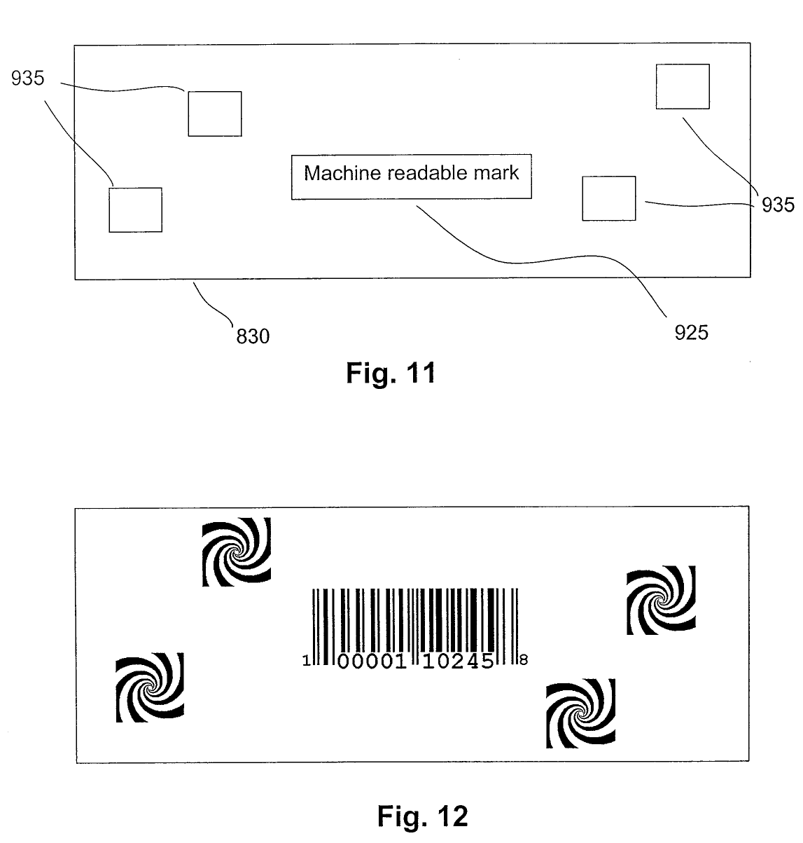

The construction of the second configuration area 830, performed in sub-step 440, is now described in more detail with reference to FIG. 6 where a schematic flow-diagram of step 440 is shown. Step 440 starts in sub-step 610 where a set of alignment marks are placed into the second configuration area 830. In the preferred implementation the second configuration area 830 is 9600 pixels wide and 2000 pixels high, and is to be printed at 1200 dpi. Four alignment marks are added to the second configuration region 830. An illustrative configuration of alignment marks 935 is shown in FIG. 11. Some representative centres of the marks are given by

M1: (x,y)=(2000, 800) (7)

M2: (x,y)=(9000, 400) (8)

M3: (x,y)=(1000, 1200) (9)

M4: (x,y)=(8000, 1600) (10)

The alignment marks 935 are preferably square with a height of 400 pixels. Other spatial positions may be used as long as no three of the alignment marks 935 are co-linear and the alignment marks 935 do not overlap any of the other alignment marks 935 in the configuration are 830. Also, the alignment marks 935 in the second configuration area 830 should not be a 180 degree rotated version of the alignment marks 930 in the first configuration area 810, and preferably their relative locations and the spatial configurations of their centres should be substantially different from the alignment marks 930 in the first configuration area 810. The alignment marks 935 placed in the second configuration area 830 are preferably of the same format as those placed in the first configuration area 810, which are preferably scale invariant spiral marks.

In sub-step 620 the chart identifier generated in step 410 is placed in the second configuration area 830 as a machine readable mark. In the preferred implementation this identifier is also a barcode where the barcode symbols are encoded using the UPC-A code format. FIG. 11 also shows a representative position for the machine readable mark 925, where the top left coordinate of the machine readable mark 925 is at (x,y)=(4000, 1000) and the lower right coordinate is at (x,y)=(6000,1500).

FIG. 12 shows an illustrative example of the second configuration area 830 showing the alignment marks 935 and the unique identifier coded in a machine readable mark 925.

Scan Analysis

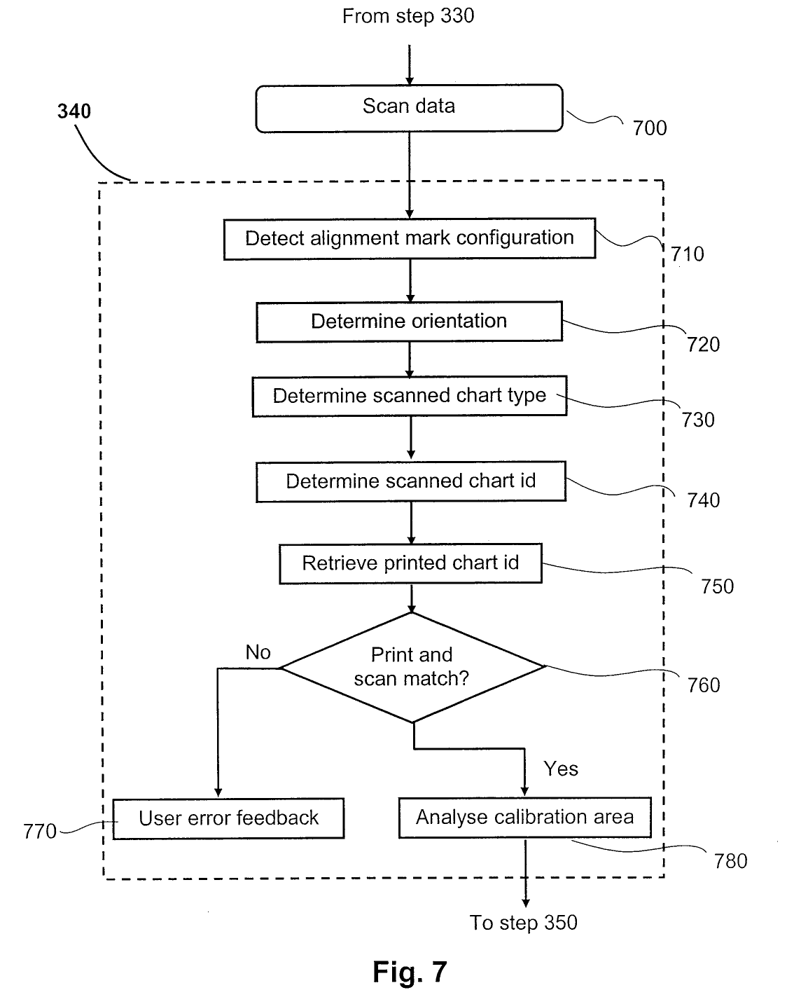

The scan analysis step 340 (FIG. 3) is now described in more detail with reference to FIG. 7 where a schematic flow diagram of step 340 is shown. The input to step 340 is scan data 700 acquired from the scanning unit 120. In particular, the scanning unit 120 provides a strip buffer of scan data containing a number of rows of the scan data. In the preferred implementation the scan is conducted at 600 dpi and the strip buffer is 4800 pixels wide by 1000 pixels high. The strip buffer is therefore large enough to contain an image of either the first or second configuration areas 810 and 830.

Step 340 starts in sub-step 710 where a detection algorithm is first run to detect the alignment marks contained in the scan data in the strip buffer. The preferred detection algorithm is correlation. One such a method is described below. The detection algorithm outputs a list of positions of the centres of the spiral patterns.

With 4 such positions detected, a linear fit of an affine transformation between the coordinates of the centres of the spiral patterns detected in the scan data and the centres of the spiral patterns in the calibration chart 800 is made. First, each of the 24 possible permutations of the correspondences between the detected spiral pattern positions and the spiral pattern positions in the first calibration area 810 is tested in turn. The correspondence which leads to the affine transform that predicts the positions of each of the spiral patterns with the smallest residual error is chosen as the transformation that maps the detected spiral pattern positions to the calibration chart spiral pattern positions.

Next, each of the 24 possible permutations of the correspondences between the detected spiral pattern positions and the spiral pattern positions in the second calibration area 830 is tested in turn. If any of these correspondences leads to an affine transform that predicts the positions of each of the spiral patterns with a smaller residual error than that chosen for the first calibration region then the affine transform that leads to the smallest error becomes the new transformation mapping the detected spiral pattern positions to the spiral pattern positions in the calibration chart.

Typically the residual error will be less than 4 scanner pixels. If the residual error is more than 4 scanner pixels then an error is deemed to have occurred.

After the affine transformation has been estimated in sub-step 710, the orientation of the calibration chart is determined in sub-step 720. If the affine transform relating the detected spiral pattern positions to the spiral pattern positions in the calibration chart was taken from correspondences with the positions of the alignment marks 930 in the first calibration area 810, then the calibration chart 800 has been placed on the platen of the scanning unit 120 with the first calibration area 810 at the top of the platen. If the affine transform relating the detected spiral pattern positions to the spiral pattern positions in the calibration chart 800 was taken from correspondences with the positions of the alignment marks 935 in the second calibration area 830, then the calibration chart 800 has been placed on the scanning unit 120 with the second calibration area 830 at the top of the scan.

Given that the positioning of the calibration chart 800 within the scan data is now known to within a few pixels, in sub-step 730 that follows the calibration chart type is detected by extracting the machine readable mark 920 or 925 from the scan data and decoding the machine readable mark 920 or 925. If the scan data has the first configuration area at the top then the machine readable mark 920 from the first configuration area 810 is extracted and decoded. If the scan data has the second configuration area 830 at the top then the machine readable mark 925 from the second configuration area 830 is extracted and decoded. This decoding is done by transforming the coordinates of the top left and bottom right of the appropriate machine readable mark 920 or 925 through the affine transform that relates the detected spiral pattern positions to the spiral pattern positions in the calibration chart 800 determined in sub-step 710. This then identifies the top left and bottom right of the machine readable mark 920 or 925 in the scan of the configuration area 810 or 830. This area is preferably extracted to form a separate image area that is analysed to decode the UPC-A encoded barcode. Methods to read UPC-A barcodes from image data are known in the art and a number of software packages for this are commercially available. Extracting the first 5 digit number from the machine readable mark 920 or 925 determines the type of the calibration chart 800 that has been scanned. In sub-step 740 the second 5 digit number is extracted to determine the identifier of the printed chart. In sub-step 750 the identifier of the last printed calibration chart is retrieved from the SRAM 209 where that identifier was stored in step 410. The respective identifiers are also compared for confirming that the identifiers match. Sub-step 760 then determines whether the identifiers match.

If it is determined that the identifiers match, then processing continues to sub-step 780 with analysis of the data captured from the calibration area 820. If it is determined in sub-step 760 that the identifiers do not match, then an error message is provided to the user in sub-step 770. This error feedback may be through the display portion of the control panel and may reference the human readable identifier placed on the calibration chart in step 530.

Preferred Alignment Mark Detection

In order to detect the positions of the spiral patterns in the strip buffer image data, the image data is correlated with a complex pattern generated from the function:

t(x, y)=(255/2)*round(1+cos(α log r+kθ)+i sin(α log r +kθ)) (11)

to form a result image. It is noted that parameters α and k are the same as those used to generate the alignment marks 930 and 935. The result image has correlation magnitude peaks at centre positions where the spiral patterns in the image data.

Advantages

The principal advantage of the preferred implementation herein described is that it allows the type of the calibration chart and its position on the scan platen to be determined before the calibration area is analysed, regardless of the orientation in which the calibration chart 800 is placed on the scanning unit 120. This then means that the MPU 201 can store in the DRAM 204 only those portions of the calibration area that are important for the calibration for later processing by the MPU 201. This greatly reduces the memory requirements of performing self calibration using the MFP scanning unit 120, which in turn reduces the cost of the MFP 100. Furthermore, as the configuration information is replicated at each end of the calibration chart 800, and there are distinct alignment patterns at each end of the calibration chart 800, it is possible to determine the necessary information regardless of which way the user places the calibration chart 800 on the scanning unit 120.

The foregoing describes only some embodiments of the present invention, and modifications and/or changes can be made thereto without departing from the scope and spirit of the invention, the embodiments being illustrative and not restrictive.

In the context of this specification, the word “comprising” means “including principally but not necessarily solely” or “having” or “including”, and not “consisting only of”. Variations of the word “comprising”, such as “comprise” and “comprises” have correspondingly varied meanings.

The claims defining the invention are as follows:

1. A method of calibrating a printing device, the method comprising the steps of:
printing a calibration chart comprising a plurality of machine readable marks and at least one calibration area, said machine readable marks being disposed on different sides of the calibration area, each machine readable mark independently identifies a type of the calibration area;
imaging the printed calibration chart; and
utilizing said calibration area to calibrate said printing device in accordance with the identity of the type of calibration area.

2. The method according to claim 1 wherein said machine readable mark further includes a unique identifier for uniquely identifying said calibration chart.

3. The method according to claim 1 wherein said calibration chart further includes a human readable label.

4. The method according to claim 2 further comprising the steps, prior to said utilizing step, of:
detecting the unique identifier in the printed calibration chart; and
confirming that the detected unique identifier matches the unique identifier included in the printed calibration chart.

5. The method according to claim 4 further comprising the step of:
providing feedback to a user if the detected unique identifier does not match the unique identifier included in the printed calibration chart.

6. The method according to claim 1 wherein said machine readable marks are scale invariant.

7. The method according to claim 1 wherein said machine readable marks are rotation invariant.

8. The method according to claim 1 wherein said machine readable marks are scale and rotation invariant.

9. A multifunction printer for calibrating a printing device, said multifunction printer comprising:
printing unit for printing a calibration chart comprising a plurality of machine readable marks and at least one calibration area, said machine readable marks being disposed on different sides of the calibration area, each machine readable mark independently identifies a type of the calibration area;
scanning unit for imaging the printed calibration chart; and
processing means for utilizing said calibration area to calibrate said printing device in accordance with the identity of the type of calibration area.

10. An apparatus for calibrating a printing device, said apparatus comprising:
printing unit for printing a calibration chart comprising a plurality of machine readable marks and at least one calibration area, said machine readable marks being disposed on different sides of the calibration area, each machine readable mark independently identifies a type of the calibration area;
scanning unit for imaging the printed calibration chart; and
processing means for utilizing said calibration area to calibrate said printing device in accordance with the identity of the type of calibration area.

11. A computer readable medium, having a program recorded thereon, where the program is configured to make a computer execute a procedure of calibrating a printing device, the program comprising:
code for printing a calibration chart comprising a plurality of machine readable marks and at least one calibration area, said machine readable marks being disposed on different sides of the calibration area, each machine readable mark independently identifies a type of the calibration area;
code for imaging the printed calibration chart; and
code for utilizing said calibration area to calibrate said printing device in accordance with the identity of the type of calibration area.
